(19) United States
(12) Patent Application Publication
(10) Pub. No.: US 2010/0157163 A1
(43) Pub. Date: Jun. 24, 2010

(54) APPARATUS FOR RECEIVING AND TRANSMITTING TELEVISION SIGNALS

(75) Inventor: Enzo Mattia Congiu', Vanzaghello (IT)

Correspondence Address: Pearne & Gordon LLP, 1801 East 9th Street, Suite 1200, Cleveland, OH, 44114-3108, US

(73) Assignee: RRD RETI RADIOTELEVISIVE DIGITALI S.R.L., 20157 MILANO (IT)

(21) Appl. No.: 12/600,915

(22) PCT Filed: May 8, 2008
(86) PCT No.: PCT/IB08/01180

§ 371 Date: Jan. 13, 2010

(30) Foreign Application Priority Data
May 22, 2007 (IT) MI2007A001030

(51) Int. Cl. H04N 5/38

(52) U.S. Cl. 348/723; 348/E05.093; 348/725; 348/E05.096

(57) ABSTRACT

An apparatus for receiving and transmitting digital television signals comprising: an input interface (10) for receiving at least one television signal (100) and at least one DVB-H signal (110); a splitting circuit (20) having an input (21) connected to said input interface (10) and a first and a second output (22, 23); an output interface (30) associated with the first output (22) of said splitting circuit (20) for outputting said television signal (100); an antenna (40) associated with the second output (23) of said splitting circuit (20) for retransmitting said DVB-H signal (110).

The present invention relates to an apparatus for receiving and transmitting television signals.

It is known that in recent years there has been a development in the technology allowing use of digital signals, in addition to “traditional” analog signals, for providing television sets with the contents that must be shown to users.

In the case of digital signals, enjoyment of these contents can take place by means of conventional television sets, associated with suitable adaptation devices (the so-called decoders), or through portable devices such as suitably-designed mobile phones or palm PDAs (Personal Digital Assistants).

Protocols used for signals of the digital type for “fixed” apparatus and portable devices are identified as DVB-T and DVB-H, respectively; the specifications of the latter are for example detailed in document ETSI EN 302 296 V1.1.1 (DVB-T) and in documents ETSI EN 302 304 V1.1.1, ETSI TR 102 473 V1.1.1, ETSI TR 102 469 V1.1.1, ETSI TR 102 401 V1.1.1, ETSI TR 102 377 V1.2.1, ETSI TS 102 472 V1.2.1, ETSI TS 102 471 V1.2.1, ETSI TS 102 470 V1.1.1 (DVB-H).

An important operating drawback that is found in use of this technology, when applied to portable devices, consists in that the signal reaching closed volumes or environments, such as domestic environments, is often too weak, attenuated, and/or disturbed so that a correct vision of the information incorporated in the signal itself is not allowed, thereby making enjoyment of the broadcasting service quite unsatisfactory.

Accordingly, it is an aim of the present invention to make available an apparatus for receiving and transmitting television signals also enabling users that are in closed areas and at least partly shielded areas, to enjoy the information addressed to their portable device in a correct and satisfactory manner.

In particular, it is an aim of the present invention to provide an apparatus for receiving and transmitting television signals enabling enjoyment of the broadcasting services addressed to portable devices, in domestic environments.

The foregoing and further aims are substantially achieved by an apparatus for receiving and transmitting television signals in accordance with the features recited in the appended claims.

Further features and advantages will become more apparent from the detailed description of a preferred but not exclusive embodiment of an apparatus in accordance with the invention.

This description is taken with reference to the accompanying drawings, given by way of non-limiting example, in which:

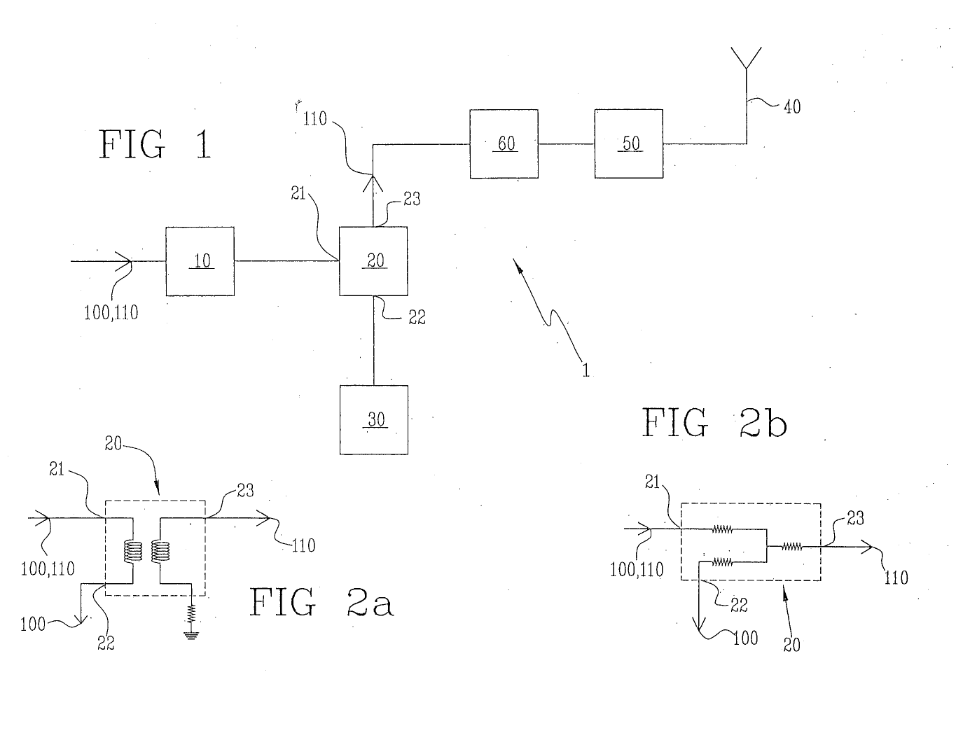

FIG. 1 shows a block diagram of an apparatus in accordance with the invention;

FIGS. 2a and 2b diagrammatically show possible embodiments of a circuit block of the apparatus in FIG. 2.

With reference to the drawings, an apparatus for receiving and transmitting television signals in accordance with the present invention has been generally identified by reference numeral 1.

Apparatus 1 (FIG. 1) first of all comprises an input interface 10 for receiving at least one television signal 100 and at least one DVB-H signal 110. The television signal 100 can be both of the analog and of the DVB-T type.

The input interface 10 is provided to be connected to conventional antenna sockets that are located at the inside of buildings and closed areas in general, for connecting television sets to antennas positioned at the outside (typically on the roof of the buildings themselves).

Through the input interface 10 apparatus 1 receives both the television signal 100 intended for a fixed apparatus, and the DVB-H signal 110 for portable devices such as mobile phones and palm PDAs.

In fact, the external antenna (not shown) to which apparatus 1 is connected, due to the input interface 10, is able to receive both the above mentioned types of signals. In other words, the television signal 100 and DVB-H signal 110 are preferably received by apparatus 1 through the same connector defined by the input interface 10.

As above mentioned, the specifications of the DVB-T and DVB-H protocols are detailed for instance in document ETSI EN 302 296 V1.1.1 (DVB-T) and in documents ETSI EN 302 304 V1.1.1, ETSI TR 102 473 V1.1.1, ETSI TR 102 469 V1.1.1, ETSI TR 102 401 V1.1.1, ETSI TR 102 377 V1.2.1, ETSI TS 102 472 V1.2.1, ETSI TS 102 471 V1.2.1, ETSI TS 102 470 V1.1.1 (DVB-H).

Apparatus 1 further comprises a splitting circuit 20 having an input 21 connected to the input interface 10 and a first and a second output 22, 23. As clarified in the following, the two distinct outputs 22, 23 are employed to output the television signal 100 and the DVB-H signal 110 in a distinct manner.

FIGS. 2a, 2b show two possible embodiments of the splitting circuit 20. In particular, FIG. 2a shows a coupling of the inductive type between input 21 and second output 23; preferably, in this first embodiment, the splitting circuit 20 is provided with an inductive divider. This solution enables input 21 to be uncoupled in a galvanic manner from the second output 23.

FIG. 2b on the contrary shows a coupling of the resistive type between input 21 and second output 23; preferably, in this second embodiment, the splitting circuit is provided with a resistive divider. A solution of this type is characterised by a great simplicity and enables apparatus 1 to be also used when an exchange is carried out between input 21 and the first output 22.

Apparatus 1 further comprises an output interface 30 associated with the first output 22 of the splitting circuit 20 for outputting the television signal 100.

The output interface 30 is preferably made as a common antenna socket for television sets. Practically, the conductive path joining input 21 to the first output defines a sort of “bypass” allowing the signal/s that is/are at the input 21 of the splitting circuit to be reproduced at the output (exactly through the output interface 30).

Interface 30 will then be connected to a fixed television set (possibly to the decoder associated therewith), so that only the television signal 100 is employed.

Apparatus 1 further comprises an antenna 40 associated with the second output 23 of the splitting circuit 20 to retransmit the DVB-H signal 110. In this manner, the DVB-H signal intercepted by the external antenna connected to input 21 of apparatus 1 can be retransmitted into the closed and/or shielded volume or environment in which apparatus 1 is positioned, so as to enable enjoyment of the audio-visual contents incorporated in the DVB-H signal 110.

Preferably, apparatus 1 further comprises an amplifier 50 operatively interposed between the second output 23 of the splitting circuit 20 and antenna 40. In the preferred embodiment, amplifier 50 operates in a band included in the range of 470 MHz to 900 MHz. Amplifier 50 can also operate in a band (referred to as L band) included in the range of 1 GHz to 2 GHz, and preferably included between 1.12 GHz and 1.7 GHz, and/or in a band (referred to as S band) included between 2 GHz and 4 GHz, and preferably between 2.6 GHz and 3.95 GHz. In particular, amplifier 50 can be of the variable-gain type; this solution is advantageous to prevent saturation of said amplifier and consequent loss of useful information.

Depending on requirements, gain control or setting of amplifier 50 can be carried out manually (by an operator through a suitable, adjustment member) or automatically (the apparatus can be able to perform an analysis of the received signal and a consequent determination of the amplifier gain, according to predetermined algorithms).

In case of use of a broad-band amplifier, the emitted power of the DVB-H signal 110 through antenna 40 has such an intensity that interferences are not created with other television apparatus possibly placed in the vicinity; this power will be sufficient to allow enjoyment of the contents of the DVB-H signal 110 by portable devices present within the range of action of apparatus 1.

The power of the DVB-H signal 110 transmitted through antenna 40 can be included, by way of example, between 0 dBm and −30 dBm, and can be equal to −10 dBm, for example.

Since the antenna—air interface has a loss of about 60 dB, the useful signal for portable devices will be included between −60 dBm and −90 dBm, and therefore sufficient for normal enjoyment of the DVB-H service, but too weak for disturbing normal reception of the television channels both of the analog and digital type on television sets present in houses.

The power of the DVB-H signal 110 is determined by suitably controlling or setting the gain of amplifier 50.

In case of use of a narrow-band amplifier, or at all events if apparatus 1 is provided with a circuit structure capable of providing a single amplified channel at the amplifier 50 output, the power of the DVB-H signal transmitted from antenna 40 can be greater. In fact, provided that the transit time of the signal within apparatus 1 is smaller than the guard interval of the digital modulation, the DVB-H signal itself will substantially supply only useful contributions for reception of information and therefore will be able to have a greater intensity.

It is to be noted that by guard interval it is intended the minimum time distance between two symbols in succession within the DVB-H transmission; details relating to this specific characteristic are reproduced in document ETSI TR 101 190 V1.2.1 (or higher), for example.

Preferably, apparatus 1 further comprises a band-pass filter 60 operatively interposed between the second output 23 of the splitting circuit 20 and antenna 40. In particular, the band-pass, filter 60 is operatively interposed between the second output 23 of the splitting circuit 20 and amplifier 50.

The band-pass filter 60 preferably has a passband centred on the frequency of the channel that has to be displayed and having a width extending from 5 MHz to 8 MHz (equal to 5, 6, 7 or 8 MHz, for example) and varying depending on applications.

In a preferred embodiment, the band-pass filter 60 is a variable-tuning filter and is interlocked with a suitable command signal, so that the passband of the filter itself is moved from a channel to the other. By way of example, the command signal can be generated by a user through one or more keys accessible from the outside of apparatus 1.

Advantageously, apparatus 1 is provided with a box-shaped holding body (not shown), in which the different circuit elements of which apparatus 1 is made are housed.

Practically, apparatus 1 can be supplied in different configurations. In a first embodiment, the presence of the input interface 10, splitting circuit 20, output interface 30, antenna 40 and variable-gain amplifier 50 is provided.

A second embodiment contemplates addition of a band-pass filter 60 of a fixed-tuning type.

In a third embodiment the band-pass filter 60 is provided to be of a variable-tuning type.

The invention achieves important advantages.

First of all, the apparatus in accordance with the invention allows correct and full enjoyment of television contents intended for portable devices, such as mobile phones and palm PDAs, also in areas where the signal presence is reduced or completely non-existent, as at the inside of some buildings.

Another advantage resides in the manufacture simplicity and the reduced production costs characterising the apparatus in accordance with the present invention.

1. An apparatus for receiving and transmitting digital television signals, comprising:
an input interface (10) for receiving at least one television signal (100) and at least one DVB-H signal (110);
a splitting circuit (20) having an input (21) connected to said input interface (10) and a first and a second output (22, 23);
an output interface (30) associated with the first output (22) of said splitting circuit (20) for outputting at least said television signal (100);
an antenna (40) associated with the second output (23) of said splitting circuit (20) for retransmitting said DVB-H signal (110).

2. An apparatus as claimed in claim 1, further comprising an amplifier (50) operatively interposed between the second output (23) of said splitting circuit (20) and said antenna (40), said amplifier (50) preferably operating in a band included between 470 MHz and 900 MHz.

3. An apparatus as claimed in claim 2, wherein said amplifier (50) is a variable-gain amplifier.

4. An apparatus as claimed in anyone of the preceding claims further comprising a band-pass filter (60.) operatively interposed between the second output (23) of said splitting circuit (20) and said antenna (40).

5. An apparatus as claimed in claim 4 when depending on claim 2, wherein said band-pass filter (60) is operatively interposed between the second output (23) of said splitting circuit (20) and said amplifier (50).

6. An apparatus as claimed in claim 4 or 5, wherein said band-pass filter (60) is a variable-tuning filter.

7. An apparatus as claimed in anyone of the preceding claims, wherein the input (21) and the second output (23) of said splitting circuit (20) are coupled in a resistive manner.

8. An apparatus as claimed in anyone of claims 1 to 7, wherein the input (21) and the second output (23) of said splitting circuit (20) are coupled in an inductive manner.

9. A process for receiving and transmitting digital television signals, comprising:
receiving at least one television signal (100) through an input interface (10);
receiving at least one DVB-H signal (110) through said input interface (10);
providing a splitting circuit (20) having an input (21) and a first and a second output (22, 23);
supplying said television signal (100) and DVB-H signal (110) to the input (21) of said splitting circuit (20);
retransmitting said television signal (100) through an output interface (30) associated with the first output (22) of said splitting circuit (20);
retransmitting said DVB-H signal (110) through an antenna (40) associated with the second output (23) of said splitting circuit (20).

10. Use of an apparatus as claimed in anyone of claims 1 to 8 for receiving a television signal (100) and a DVB-H signal (110) and retransmitting them.
